(19) United States
(12) Patent Application Publication
(10) Pub. No.: US 2025/0015536 A1
(43) Pub. Date: Jan. 9, 2025

(54) CONNECTOR

(71) Applicant: SUMITOMO WIRING SYSTEMS, LTD., Mie (JP)

(72) Inventors: Hiroto SAKAI, Mie (JP); Ryota YONEMITSU, Mie (JP)

(21) Appl. No.: 18/761,766

(22) Filed: Jul. 2, 2024

(30) Foreign Application Priority Data
Jul. 3, 2023 (JP) 2023-109279

(51) Int. Cl. H01R 13/629

(52) U.S. Cl. CPC H01R 13/62938

(57) ABSTRACT

A moving plate 44 includes a peripheral wall portion 73 disposed along an inner surface of a hood portion 56 of a male housing 42, a plate body 72 for positioning a tab 45 inside the hood portion 56, and an escape portion 82 that extends through the peripheral wall portion 73 in the thickness direction. The female housing 12 is disposed inside the peripheral wall portion 73. Either the female housing 12 or the hood portion 56 has a protrusion 28, and the other one has a recess 63. In a fitting state where the female connector 10 and the male connector 40 are fitted to each other, a base end side of the protrusion 28 is disposed inside the escape portion 82, and a distal end side of the protrusion 28 is fitted and positioned in the recess 63.

### CROSS-REFERENCE TO RELATED APPLICATIONS

This application is based on and claims priority from Japanese Patent Application No. 2023-109279, filed on Jul. 3, 2023, with the Japan Patent Office, the disclosure of which is incorporated herein in its entirety by reference.

### TECHNICAL FIELD

The present disclosure relates to a connector.

### BACKGROUND

A connector disclosed in JP 2010-146930 A includes a male connector having a hood portion, a female connector fitted into the hood portion, and a moving plate for positioning a male terminal. The male terminal is protected inside the hood portion by the moving plate. At the time of fitting, the female connector is surrounded by a peripheral wall portion of the moving plate inside the hood portion. A female terminal accommodated in the female connector is electrically connected to the male terminal. A connector provided with a moving plate is also disclosed in JP H05-043485 U.

### SUMMARY

At the time of fitting, a male terminal is guided into a female connector by a guiding portion formed on a fitting surface of the female connector, and connected to the female terminal. In the case of JP 2010-146930 A, the female connector is disposed inside the moving plate, and the moving plate is disposed inside the hood portion. With this configuration, due to accumulation of assembly error (including assembly tolerance) between the female connector and the moving plate and assembly error between the moving plate and the hood portion, the guiding portion of the female connector may be displaced from a position at which the guiding portion of the female connector can guide the male terminal, which may result in the male terminal interfering with a housing portion of the female connector. Note that in JP 2010-146930 A, a receiving groove of the hood portion merely receives a guide rib of the female connector.

In view of this, an object of the present disclosure is to provide a connector capable of appropriately realizing a state where a male terminal can be connected to a female terminal.

A connector according to the present disclosure is a connector including a female connector and a male connector that are fittable to each other, and the female connector includes a female terminal and a female housing configured to house the female terminal, the male connector includes a male terminal, a male housing configured to house the male terminal, and a moving plate movable in a fitting direction with respect to the male housing, the male terminal includes a tab, the male housing includes a hood portion from which the tab protrudes, the moving plate includes a peripheral wall portion disposed along an inner surface of the hood portion, a plate body configured to position the tab inside the hood portion, and an escape portion extending through the peripheral wall portion in a thickness direction, the female housing is disposed inside the peripheral wall portion, either one of the female housing and the hood portion has a protrusion, and another one of the female housing and the hood portion has a recess, and in a fitting state of the female connector and the male connector, a base end side of the protrusion is disposed inside the escape portion, and a distal end side of the protrusion is fitted and positioned in the recess.

According to the present disclosure, it is possible to provide a connector capable of appropriately realizing a state where a male terminal can be connected to a female terminal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a female connector of a connector according to a first embodiment.

FIG. 2 is an exploded perspective view of the female connector of the connector according to the first embodiment.

FIG. 3 is a perspective view of a female holder of the connector according to the first embodiment.

FIG. 4 is a perspective view of a male connector of the connector according to the first embodiment.

FIG. 5 is an exploded perspective view of the male connector of the connector according to the first embodiment.

FIG. 6 is a perspective view of a male holder of the connector according to the first embodiment.

FIG. 7 is a perspective view of a moving plate of the connector according to the first embodiment.

FIG. 8 is a cross-sectional view of the male connector of the connector according to the first embodiment, showing a state where a lever is disposed at a stand-by position with respect to a male housing, and the moving plate is disposed at a protected position with respect to the male housing.

FIG. 9 is a cross-sectional view of the connector according to the first embodiment, showing a state where the female connector is disposed inside a peripheral wall portion of the moving plate after the state shown in FIG. 8.

FIG. 10 is a cross-sectional view showing a state where the lever has been rotated to a completely rotated position and the moving plate is disposed at a fitting position with respect to the male housing after the state shown in FIG. 9.

FIG. 11 is a partially-cut front view of the connector according to the first embodiment, showing, in an enlarged manner, a state where a base end side of a protrusion is disposed inside an escape portion, and a distal end side of the protrusion has been positioned in a recess.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF THE PRESENT DISCLOSURE

First, aspects of the present disclosure will be listed and described.

(1) A connector according to the present disclosure is a connector including a female connector and a male connector that are fittable to each other, and the female connector includes a female terminal and a female housing configured to house the female terminal, the male connector includes a male terminal, a male housing configured to house the male terminal, and a moving plate movable in a fitting direction with respect to the male housing, the male terminal includes a tab, the male housing includes a hood portion from which the tab protrudes, the moving plate includes a peripheral wall portion disposed along an inner surface of the hood portion, a plate body configured to position the tab inside the hood portion, and an escape portion extending through the peripheral wall portion in a thickness direction, the female housing is disposed inside the peripheral wall portion, either one of the female housing and the hood portion has a protrusion, and another one of the female housing and the hood portion has a recess, and in a fitting state of the female connector and the male connector, a base end side of the protrusion is disposed inside the escape portion, and a distal end side of the protrusion is fitted and positioned in the recess.

By the distal end side of the protrusion being fitted into the recess in the positioned state, displacement of the female housing relative to the hood portion can be prevented. As a result, the state where the male terminal, which protrudes into the hood portion, is guided into the female housing and connected to the female terminal can be appropriately realized.

(2) It is preferable that, with respect to a width direction orthogonal to a height direction that is a direction in which the protrusion protrudes and the recess is recessed, a gap in the width direction that is possibly formed between an outer surface on the base end side of the protrusion and an inner surface of the escape portion is set larger than a gap in the width direction that is possibly formed between an inner surface on the distal end side of the protrusion and an inner surface of the recess.

Since a gap in the width direction can be formed between the outer surface on the base end side of the protrusion and the inner surface of the escape portion, interference of the protrusion with the inner surface of the escape portion can be avoided. As a result, the state where the distal end side of the protrusion is positioned in the width direction in the recess can be more appropriately realized.

(3) It is preferable that, with respect to a width direction orthogonal to a height direction that is a direction in which the protrusion protrudes and the recess is recessed, the female housing, the male housing, and the moving plate are longer in the width direction than in the height direction, the protrusion is formed in a center region in the width direction of a long side portion of the one of the female housing and the hood portion, the escape portion is formed in a center region in the width direction of a long side portion of the peripheral wall portion, and the recess is formed in a center region in the width direction of a long side portion of the other one of the female housing and the hood portion.

Since the fitting part where the recess and the protrusion are fitted is formed in the center region in the width direction of the long side portions of the female housing and the hood portion, displacement in the width direction of the female housing and the hood portion can be effectively prevented with a simple structure.

(4) It is preferable that the male connector includes a lever supported rotatable with respect to the male housing, the lever includes a cam groove, the male housing includes a pin escape portion in a center region in the height direction of a short side portion, the peripheral wall portion includes a male cam pin configured to be disposed inside the cam groove via the pin escape portion, in a center region in the height direction of a short side portion, and the female housing includes a female cam pin configured to be combined with the male cam pin, in a center region in the height direction of a short side portion.

The female cam pin, the pin escape portion, and the male cam pin are disposed in the center region in the height direction of the short side portions, and the recess, the escape portion, and the protrusion are disposed in the center region in the width direction of the long side portions, and thus it is possible to reduce structural constraints between the structures of the female cam pin, the pin escape portion, and the male cam pin and the structures of the recess, the escape portion, and the protrusion.

(5) It is preferable that the female housing includes a female housing body configured to hold the female terminal, and a female holder surrounding the female housing body, the male housing includes a male housing body configured to hold the male terminal, and a male holder surrounding the male housing body, and the protrusion is formed on the one of the female holder and the male holder, and the recess is formed in the other one of the female holder and the male holder.

With the configuration of (5), by the distal end side of the protrusion being fitted and positioned in the recess, the fitting state of the connector can be realized, and the connection state of the female terminal and the male terminal can be realized. There is no need for forming a recess or protrusion in the female housing body and the male housing body.

### DETAILS OF EMBODIMENTS OF THE PRESENT DISCLOSURE

The following describes specific examples of a connector according to the present disclosure with reference to the drawings. Note that the present invention is not limited to these examples and is defined by the claims, and all changes that fall within the equivalent meaning and scope of the claims are intended to be included therein.

### First Embodiment

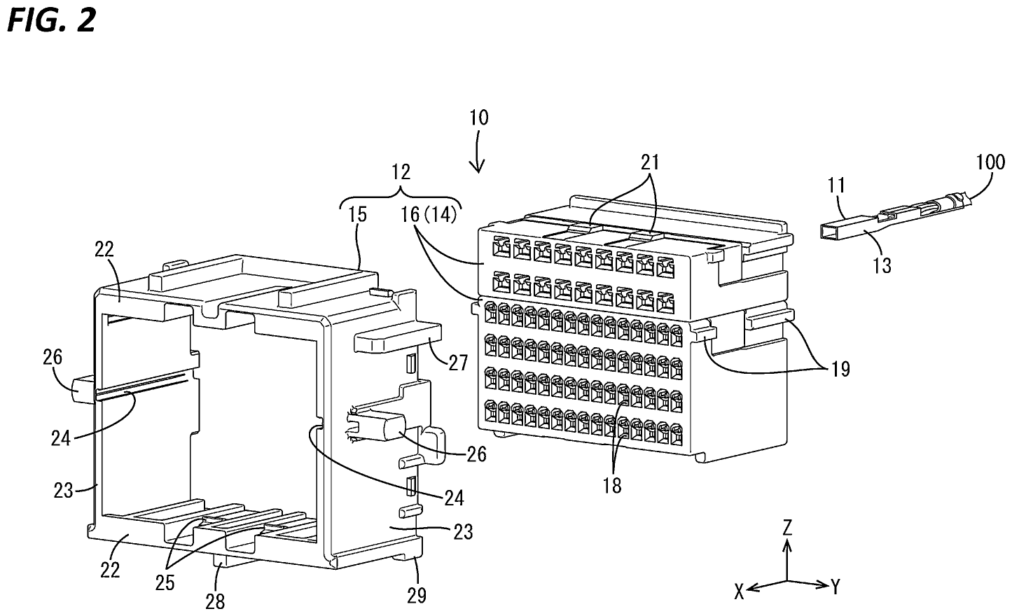

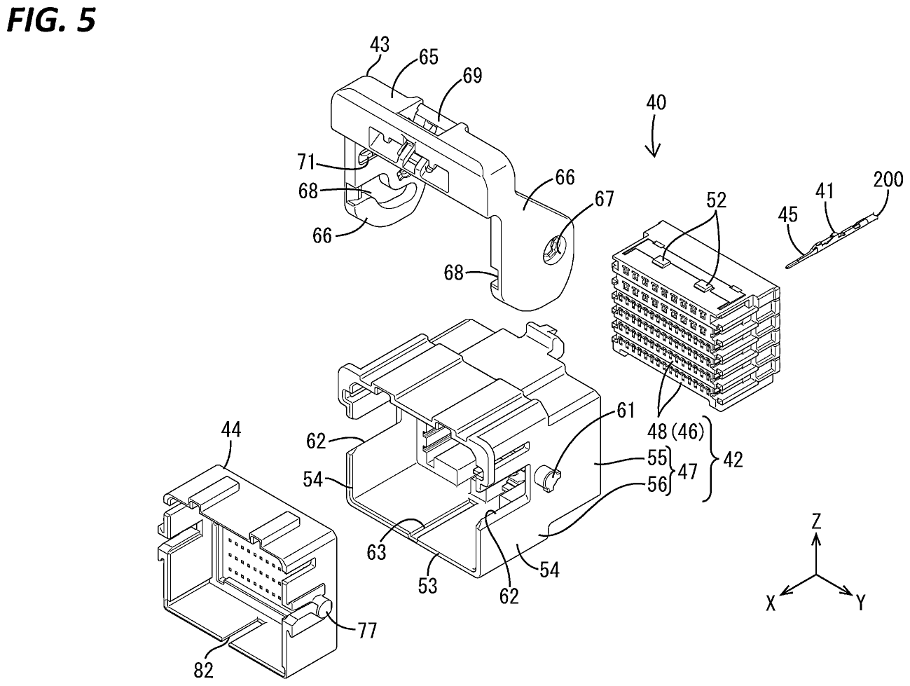

A connector according to a first embodiment of the present disclosure includes a female connector 10 and a male connector 40 that can be fitted to each other. As shown in FIG. 2, the female connector 10 includes a female terminal 11 and a female housing 12. As shown in FIG. 5, the male connector 40 includes a male terminal 41, a male housing 42, a lever 43, and a moving plate 44. Note that, in the following description, with respect to the front-rear direction, the front side is the side on which the female connector 10 and the male connector 40 are fitted to each other. The up-down direction is based on the up-down direction in the drawings. The left-right direction is based on the left-right direction when the female connector 10 or the male connector 40 is viewed from the front. In the first embodiment, the up-down direction has the same meaning as the height direction, and the left-right direction has the same meaning as the width direction. In the following description, the up-down direction may be referred to as the height direction, and the left-right direction may be referred to as the width direction. The references of these directions may not necessarily match the references of the directions in the state where the connector is mounted in a vehicle or the like which is not shown. In FIGS. 2 and 5, the front side is indicated by the arrow X, the right side is indicated by the arrow Y, and the upper side is indicated by the arrow Z.

### (Female Connector 10)

The female terminal 11 is a single body formed by bending a conductive metal plate, for example. As shown in FIG. 2, the female terminal 11 is connected to an end portion of a wire 100. The female terminal 11 has a tubular connection portion 13.

The female housing 12 is made of a synthetic resin, and includes a female housing body 14 for housing the female terminal 11, and a female holder 15 that surrounds the female housing body 14. The female housing body 14 is constituted by upper and lower female sub housings 16.

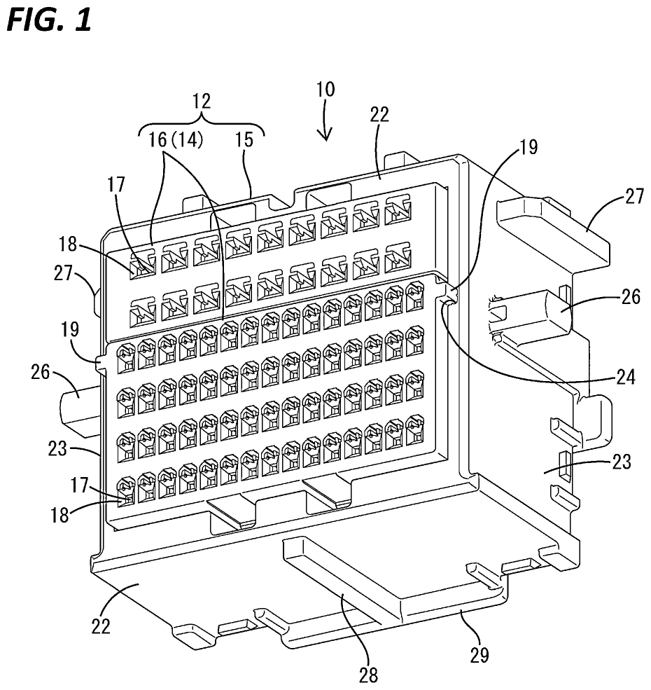

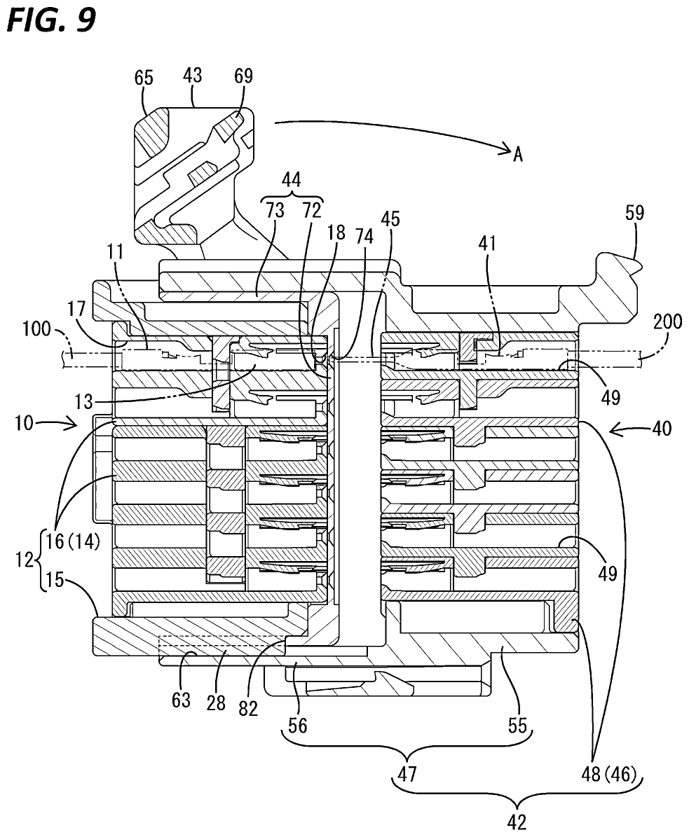

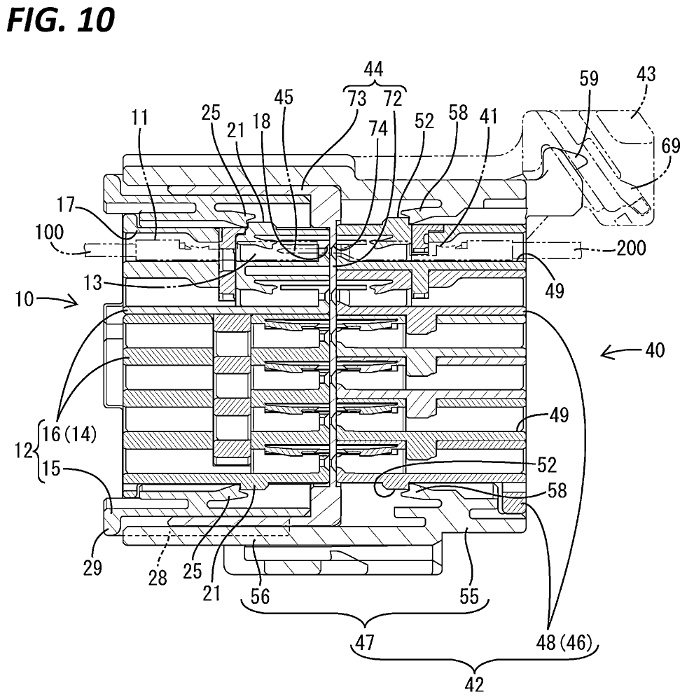

The female sub housings 16 have a rectangular block shape. As shown in FIGS. 9 and 10, the female sub housings 16 each have a plurality of female cavities 17. The female terminals 11 are inserted into the corresponding female cavities 17 from the rear and held. As shown in FIG. 1, the female sub housings 16 each have a guiding portion 18 that widens from a front end of each female cavity 17 toward a front surface. Of the female sub housings 16, the up-down dimension of the lower female sub housing 16 is larger than that of the upper female sub housing 16. As shown in FIG. 2, the lower female sub housing 16 has a pair of protruding female ribs 19 extending in the front-rear direction on the upper end side of each of left and right side surfaces thereof. In addition, as shown in FIG. 10, the female sub housings 16 each have a female lock portion 21 that can be locked to the female holder 15. The female lock portions 21 respectively protrude on a lower surface of the lower female sub housing 16 and an upper surface of the upper female sub housing 16.

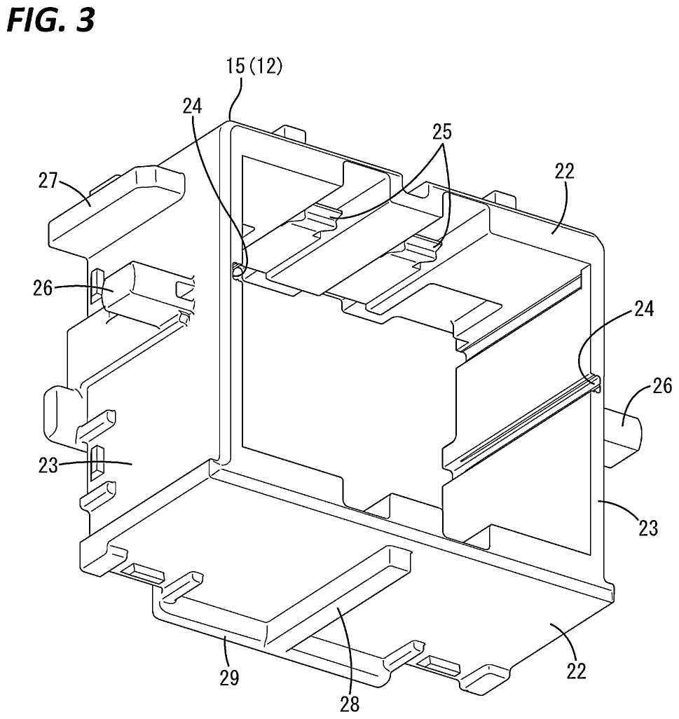

As shown in FIG. 3, the female holder 15 has a rectangular tube shape. The female holder 15 is longer in the width direction than in the height direction. In other words, in the female holder 15, the width dimensions of upper and lower walls that oppose each other in the height direction are larger than the height dimensions of left and right side walls that oppose each other in the width direction. In other words, the upper and lower walls of the female holder 15 form a pair of long side portions 22, and the left and right side walls of the female holder 15 form a pair of short side portions 23.

The female holder 15 has a pair of female rib receiving portions 24 that extend in the front-rear direction and are open forward, on inner surfaces of the short side portions 23. The female holder 15 has a pair of elastically deformable female lock arms 25 that protrude on the inner surface of each of the long side portions 22.

At the time of assembly, the lower female sub housing 16 is inserted into the lower side of the inside of the female holder 15 from the rear. By the female ribs 19 being fitted to the female rib receiving portions 24 and the female lock portions 21 being locked to the lower female lock arms 25, the lower female sub housing 16 is held by the female holder 15. Next, the upper female sub housing 16 is inserted into the upper portion of the inside of the female holder 15. By the upper female sub housing 16 being stacked on the lower female sub housing 16 and the female lock portions 21 being locked to the upper female lock arms 25, the upper female sub housing 16 is held by the female holder 15 (see FIG. 1).

As shown in FIGS. 1 to 3, the female holder 15 has a pair of female cam pins 26 respectively protruding from a center region in the height direction of outer surfaces of the short side portions 23. The female cam pins 26 are shaped as plates flattened in the front-rear direction. The female holder 15 has a pair of release portions 27 respectively protruding from upper end sides of the outer surfaces of the short side portions 23. The release portions 27 are shaped as plates extending in the front-rear direction. As described later, the release portions 27 unlock a temporary lock state of the lever 43.

Also, the female holder 15 includes one protrusion 28 protruding from a center region in the width direction on the outer surface of the lower long side portion 22. The protrusion 28 is shaped as a rib that has a rectangular cross section and extends in the front-rear direction. The front end of the protrusion 28 is located slightly rearward of a front end edge of the lower long side portion 22. As shown in FIGS. 1 and 3, the rear end of the protrusion 28 is integrally connected to a protruding ridge portion 29 formed on a rear end edge of the lower long side portion 22. The protruding ridge portion 29 is shaped as a rib extending in the width direction on the rear end edge of the lower long side portion 22. The protruding ridge portion 29 is disposed so as to be exposed toward the rear end side of the female connector 10 (rear end side as viewed from the female connector 10) in a fitting state where the female connector 10 and the male connector 40 are fitted to each other.

### (Male Connector 40)

The male terminal 41 is a single body formed by bending a conductive metal plate, for example. As shown in FIG. 5, the male terminal 41 is connected to an end portion of a wire 200. The male terminal 41 includes a tab 45 protruding forward. When the female connector 10 and the male connector 40 are fitted to each other, the tab 45 is inserted into the connection portion 13 while being guided by the guiding portion 18, and the male terminal 41 and the female terminal 11 are electrically connected to each other (see FIGS. 9 and 10).

The male housing 42 is made of a synthetic resin, and includes a male housing body 46 for housing the male terminal 41, and a male holder 47 that surrounds the male housing body 46. The male housing body 46 is formed by a plurality of male sub housings 48 stacked in the up-down direction.

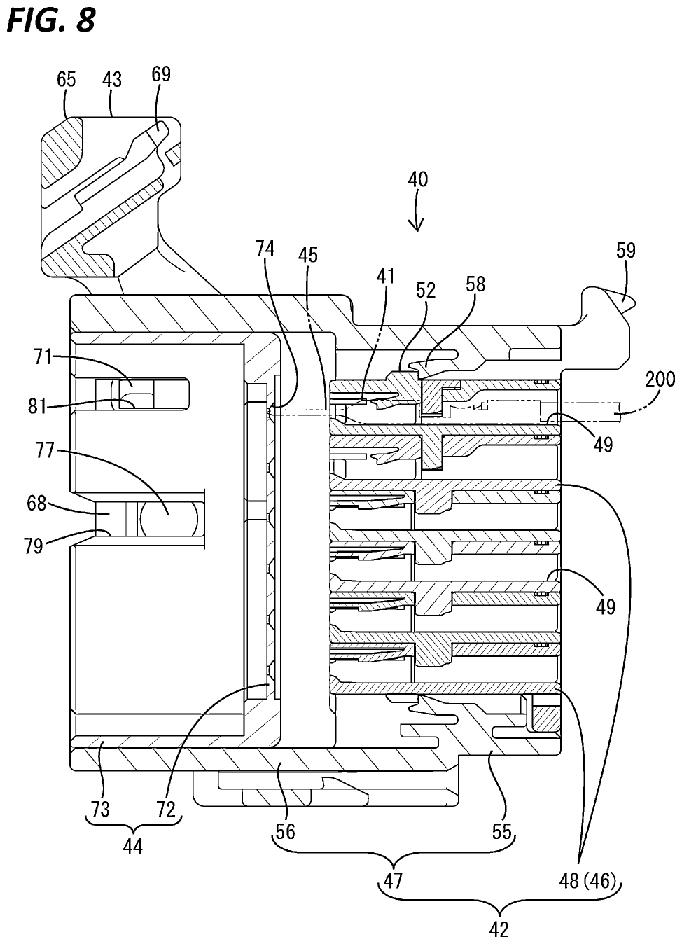

As shown in FIG. 5, the male sub housings 48 are each shaped as a flattened block that is rectangular in plan view. As shown in FIGS. 8 to 10, the male sub housings 48 each have a plurality of male cavities 49 arranged in the width direction. Each male terminal 41 is inserted into a corresponding male cavity 49 from the rear and held. The male sub housings 48 each have a pair of protruding male ribs 51 respectively extending in the front-rear direction on the left and right side surfaces thereof. Of the male sub housings 48, the male sub housings 48 disposed on the uppermost and lowermost levels each have male lock portions 52 capable of being locked to the male holder 47. The male lock portions 52 protrude from an upper surface of the male sub housing 48 at the uppermost level and the lower surface of the male sub housing 48 at the lowermost level.

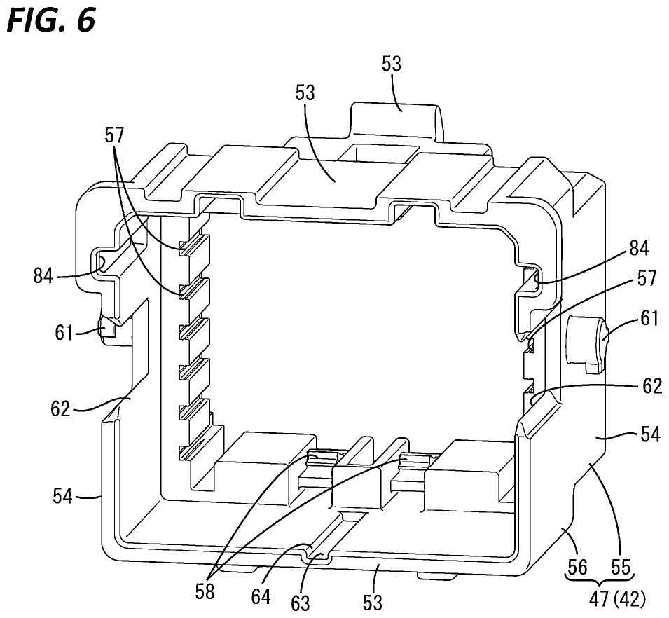

As shown in FIG. 6, the male holder 47 has a rectangular tube shape. The male holder 47 has a shape that is longer in the width direction than in the height direction. In other words, in the male holder 47, width dimensions of the upper and lower walls that oppose each other in the height direction are larger than height dimensions of the left and right side walls that oppose each other in the width direction. In other words, the upper and lower walls of the male holder 47 form a pair of long side portions 53, and the left and right side walls of the male holder 47 form a pair of short side portions 54.

The male holder 47 has a sub housing holding portion 55 for holding the male sub housings 48, and a hood portion 56 protruding forward from an outer peripheral edge of the front surface of the sub housing holding portion 55. As shown in FIG. 8, the tabs 45 of the male terminals 41 held by the male sub housings 48 are disposed so as to protrude into the hood portion 56.

As shown in FIG. 6, the male holder 47 has a plurality of male rib receiving portions 57 that extend in the front-rear direction and are open forward, on the inner surface of each of the short side portions 54 of the sub housing holding portion 55. The male rib receiving portions 57 are arranged in the up-down direction at positions corresponding to the male sub housings 48. In addition, the male holder 47 has a pair of elastically-deformable male lock arms 58 protruding on the inner surface of each of the long side portions 53 of the sub housing holding portion 55.

When assembling the male connector 40, the male sub housings 48 are integrated with each other in the up-down direction, and then inserted into the sub housing holding portion 55 of the male holder 47 from the rear. The male ribs 51 are fitted to the male rib receiving portions 57, and the male lock portions 52 at the uppermost and lowermost levels are locked to the male lock arms 58, and thus all of the male sub housings 48 are held by the sub housing holding portion 55 of the male holder 47 (see FIG. 8).

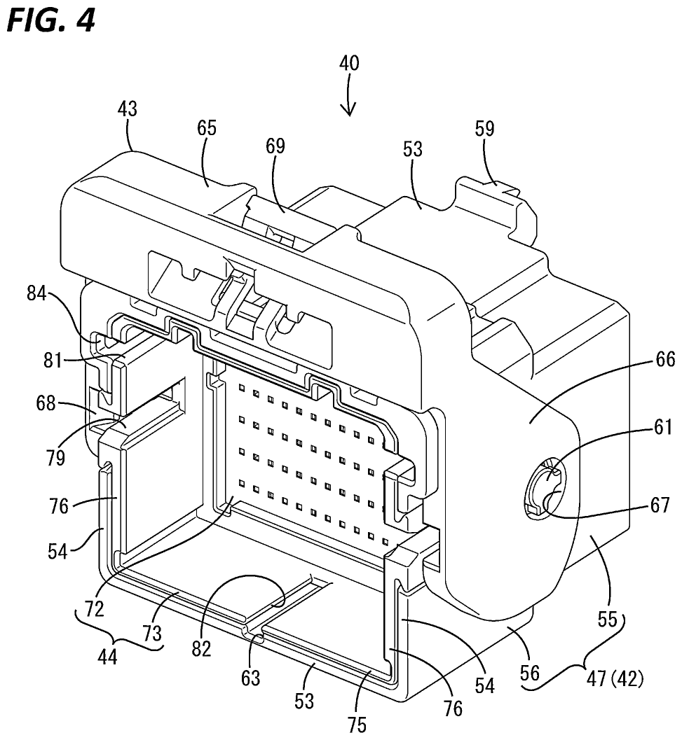

As shown in FIGS. 4 to 6, in the male holder 47, a lever lock receiving portion 59 protrudes from the upper long side portion 53 of the sub housing holding portion 55. The lever lock receiving portion 59 protrudes rearward from the upper long side portion 53, and protrudes upward from the rear end side thereof.

As shown in FIG. 6, a pair of support shafts 61 respectively protrude from the center region in the height direction of the outer surfaces of the short side portions 54 of the male holder 47. The lever 43 is rotatably supported by the support shafts 61. A pair of pin escape portions 62 that extend in the front-rear direction and are open forward are respectively provided in the center region in the height direction of the short side portions 54 of the hood portion 56 of the male holder 47. The pin escape portions 62 are disposed frontward of the support shafts 61. The male holder 47 has a pair of temporary lock receiving portions 84 that respectively extend in the front-rear direction and are open forward on the inner surfaces on the upper end sides of the short side portions 54.

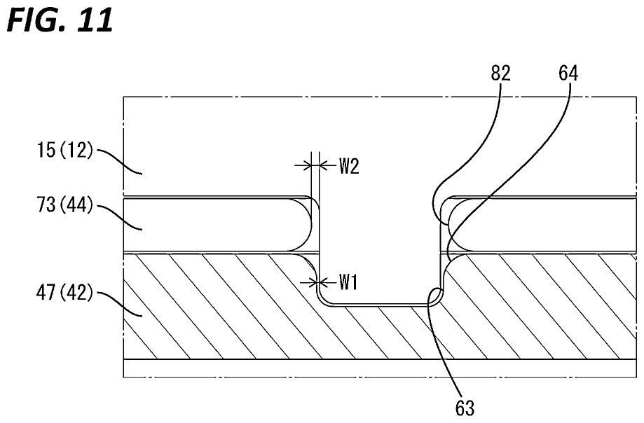

Also, one recess 63 is provided in an inner surface in the center region in the width direction of the lower long side portion 53 of the hood portion 56 of the male holder 47. The recess 63 is recessed in the inner surface in the center region in the width direction of the long side portion 53. Specifically, the recess 63 extends in the front rear direction on the inner surface in the center region in the width direction of the long side portion 53 and is open forward. A rear end of the recess 63 is closed near the front surface of the sub housing holding portion 55. As shown in FIG. 11, the recess 63 has a rectangular cross sectional shape that conforms to a distal end side of the protrusion 28, except for a chamfered portion 64 formed at an opening edge. The distal end side of the protrusion 28 is fitted and positioned in the recess 63.

The lever 43 is made of a synthetic resin, and as shown in FIG. 4, is attached to the male holder 47 so as to bridge it from above. As shown in FIG. 5, the lever 43 has a coupling portion 65 that has a bridge-like plate shape extending in the width direction, and a pair of arm portions 66 protruding from two end portions in the width direction of the coupling portion 65. The arm portions 66 each have a shaft hole 67 for receiving the corresponding support shaft 61. A cam groove 68 is provided in an inner surface of each arm portion 66. The entrance of the cam groove 68 is open at the outer peripheral edge of each arm portion 66. The lever 43 has an elastically deformable lever lock portion 69 in the center portion in the width direction of the coupling portion 65. A pair of elastically deformable temporary lock portions 71 (only one is shown in FIG. 5) are respectively formed on the inner surfaces of the arm portions 66.

The lever 43 is rotatable, with respect to the male holder 47, between a temporary lock position and a lock position about the support shafts 61 fitted into the shaft holes 67. At the temporary lock position, the temporary lock portions 71 are locked by the temporary lock receiving portions 84 of the male holder 47, and rotation of the lever 43 to the lock position is restricted. In addition, at the temporary lock position, as shown in FIGS. 8 and 9, the coupling portion 65 is disposed upward of a front-end portion of the male housing 42. At the lock position, as shown in FIG. 10, the coupling portion 65 is disposed rearward and upward of the rear end portion of the male housing 42, and the lever lock portion 69 is locked to the lever lock receiving portion 59. In this manner, the lever 43 is held at the lock position, and rotation thereof is restricted.

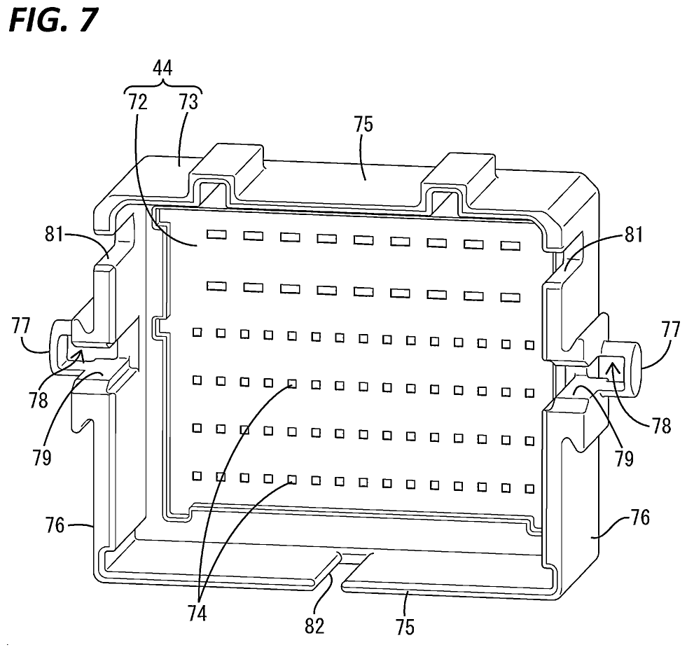

The moving plate 44 is made of a synthetic resin, and is box-shaped and plate-shaped overall. As shown in FIG. 7, the moving plate 44 has a plate body 72 disposed such that its plate surfaces face in the front-rear direction, and a peripheral wall portion 73 disposed such that its plate surfaces face inward and outward in a radial direction (the up-down direction and left-right direction). The moving plate 44 can move in the front-rear direction between a protected position (see FIGS. 8 and 9) and a fitting position (see FIG. 10) with respect to the male housing 42 while being disposed inside the hood portion 56.

The plate body 72 has a rectangular shape elongated in the left-right direction as viewed from the front, and is disposed so as to cover the inside of the hood portion 56. As shown in FIG. 7, the plate body 72 has a plurality of positioning holes 74 that pass through in the front-rear direction (thickness direction). The tabs 45 of the male terminals 41 protruding inside the hood portion 56 are respectively inserted into and positioned in the positioning holes 74.

The peripheral wall portion 73 has a rectangular tube shape, and is disposed along an inner surface of the hood portion 56. As shown in FIG. 7, the peripheral wall portion 73 has a shape that is longer in the width direction than in the height direction. In other words, in the peripheral wall portion 73, the width dimensions of the upper and the lower walls that oppose each other in the height direction are larger than the height dimensions of the left and right side walls that oppose each other in the width direction. In other words, the upper and lower walls of the peripheral wall portion 73 form a pair of long side portions 75, and the left and right side walls of the peripheral wall portion 73 form a pair of short side portions 76.

The peripheral wall portion 73 has a pair of male cam pins 77 respectively protruding from the center region in the height direction of the outer surface of the short side portions 76. The male cam pins 77 each have a cylindrical outer shape, and an inner space 78 that is open forward. The peripheral wall portion 73 has a pair of pin introduction portions 79 that respectively extend in the front-rear direction and are open forward, in the center region in the height direction of the short side portions 76. The pin introduction portions 79 are in communication with the inner spaces 78 of the male cam pins 77. Also, the peripheral wall portion 73 has a pair of release introduction portions 81 that respectively extend in the front-rear direction and are open forward, on the upper end sides of the short side portions 76.

As shown in FIG. 7, the peripheral wall portion 73 has one escape portion 82 extending in the front-rear direction and that is open forward, in a center portion in the width direction of the lower long side portion 75. The escape portion 82 passes through the lower long side portion 75 in the up-down direction (thick direction of the lower long side portion 75). A rear end of the escape portion 82 is closed near a front surface of the plate body 72. As shown in FIGS. 4 and 11, the escape portion 82 is in communication with the recess 63 in the up-down direction in the state where the moving plate 44 is disposed inside the hood portion 56. The width dimension of the escape portion 82 is larger than the width dimension of the protrusion 28 and larger than the width dimension of the recess 63, except for the chamfered portion 64.

### (Assembly and Fitting of Connector)

Next, an example of operations of assembly and fitting of the connector will be described.

When assembling the female connector 10 and the male connector 40, with respect to the female connector 10, first, the female terminals 11 and the male terminals 41 are connected to the end portions of the corresponding wires 100 and 200. In this state, the female terminals 11 are inserted into the respective female cavities 17, and the female sub housings 16 are housed in the female holder 15. In this manner, assembly of the female connector 10 is complete (see FIG. 1).

With respect to the male connector 40, first, the lever 43 is supported at the temporary lock position with respect to the male housing 42. At the temporary lock position, the temporary lock portions 71 are respectively locked to the temporary lock receiving portions 84 and the entrances of the cam grooves 68 are in communication with the pin escape portions 62 and are open forward.

Then, the moving plate 44 is inserted into the hood portion 56. Here, the male cam pins 77 respectively enter the pin escape portions 62, and are fitted into the entrances of the cam grooves 68. In this manner, the moving plate 44 is disposed at the protected position with respect to the male housing 42. At the protected position, the plate body 72 is spaced apart from the sub housing holding portion 55 on the side corresponding to the opening end of the hood portion 56, and the opening ends of the peripheral wall portion 73 and the hood portion 56 are aligned in the front-rear direction (see FIG. 8). In addition, the escape portion 82 is in communication with the recess 63 along the front-rear direction, and the release introduction portions 81 are in communication with the temporary lock receiving portions 84 (see FIG. 4).

Also, the male terminals 41 are respectively inserted into the male cavities 49, and the male sub housings 48 are housed in the sub housing holding portion 55 of the male holder 47. The distal end sides of the tabs 45 of the male terminals 41 reach the plate body 72, are fitted into the positioning holes 74 inside the hood portion 56, and are protected by the moving plate 44 (see FIG. 8). In this manner, assembly of the male connector 40 is complete.

When fitting the female connector 10 and the male connector 40 together, the female housing 12 is inserted into the hood portion 56. The female housing 12 is disposed inside the peripheral wall portion 73, and is surrounded by the moving plate 44 (see FIG. 9). The front surfaces of the female sub housings 16 (front surfaces as viewed from the female connector 10) oppose the plate body 72 such that the front surfaces can come into contact with the plate body 72. The guiding portions 18 are in communication with the respective positioning holes 74. In this manner, when the moving plate 44 is at the protected position, the female terminals 11 are spaced apart from the tabs 45 of the male terminals 41, and are maintained in a state of not being in contact with the male terminals 41.

The release portions 27 respectively enter the temporary lock receiving portions 84 via the release introduction portions 81, and interfere with the temporary lock portions 71 locked to the temporary lock receiving portions 84. The temporary lock portions 71 are elastically deformed outward by being pressed by the release portions 27, and thus become unlocked from the temporary lock receiving portions 84. Therefore, the lever 43 can rotate toward the lock position.

When the female housing 12 is disposed inside the peripheral wall portion 73, the female cam pins 26 respectively enter the inner spaces 78 of the male cam pins 77 via the pin introduction portions 79. In this manner, the female cam pins 26 and the male cam pins 77 are combined with each other to be one piece. Further, when the female housing 12 is disposed inside the peripheral wall portion 73, the protrusion 28 is fitted into the recess 63 via the escape portion 82 as shown in FIGS. 9 and 11. Specifically, a portion on the base-end side of the protrusion 28 (in the first embodiment, the upper half portion of the protrusion 28) is disposed inside the escape portion 82, and a portion on the distal end side of the protrusion 28 (in the first embodiment, the lower half portion of the protrusion 28) is fitted into and positioned in the recess 63.

As shown in FIG. 11, between left and right surfaces of the lower-half portion of the protrusion 28 (surfaces facing opposite sides in the width direction) and left right surfaces (surfaces facing each other in the width direction) of the recess 63, a gap in the width direction (W1) is formed, or no gap is formed (W1=0). Between left and right surfaces of the upper-half portion of the protrusion 28 and left and right surfaces of the escape portion 82 (surfaces facing each other in the width direction), a gap in the width direction (W2) that is larger than the gap in the width direction (W1) is formed (W1<W2). Accordingly, the left and right surfaces of the upper-half portion of the protrusion 28 and the left and right surfaces of the escape portion 82 can be maintained in a state of not being in contact with each other. Also, a front end of the protrusion 28 (front end when viewed from the female connector 10) faces a back end (rear end when viewed from the male connector 40) of the escape portion 82 such that the front end can come into contact with the back end.

In this manner, by the lower-half portion of the protrusion 28 being fitted into and positioned in the recess 63, regardless of assembly error (including assembly tolerance) that maybe formed between the moving plate 44 and the female holder 15 or the male holder 47, relative displacement between the female holder 15 and the male holder 47 is restricted.

In the state where the female housing 12 is disposed inside the peripheral wall portion 73, the coupling portion 65 is pinched and the lever 43 is rotated in the direction indicated by the arrow Ain FIG. 9. In the process of rotating the lever 43, the male cam pins 77 that have been combined with the corresponding female cam pins 26 slide on the groove surfaces of the cam grooves 68, and the moving plate 44 moves toward the fitting position along with the female housing 12.

When the moving plate 44 starts movement toward the fitting position, the distal end sides of the tabs 45 of the male terminals 41 protrude from the positioning holes 74. The distal end sides of the tabs 45 of the male terminals 41 protruding from the positioning holes 74 enter the corresponding female cavities 17 via the guiding portions 18. Since the female terminals 11 are respectively housed in the female cavities 17, the tabs 45 of the male terminals 41 are respectively inserted into the connection portions 13 of the female terminals 11. As movement toward the fitting position proceeds, the tabs 45 of the male terminals 41 are respectively inserted deeper into the connection portions 13 of the female terminals 11. As shown in FIG. 10, when the moving plate 44 reaches the fitting position, the tabs 45 of the male terminals 41 are inserted into the connection portions 13 at a proper depth, and thereby the female terminals 11 and the male terminals 41 are electrically connected to each other. Also, the lever 43 also reaches the lock position, and the lever lock portion 69 is locked to the lever lock receiving portion 59. In this manner, rotation of the lever 43 is restricted, and the female connector 10 and the male connector 40 are held in the fitted state.

As described above, in the first embodiment, by the distal end side of the protrusion 28 being fitted into the recess 63 in the positioned state, relative displacement between the female holder 15 and the male holder 47 is restricted, and as a result of that, relative displacement between the female housing 12 and the male housing 42 is restricted. The male terminals 41 are housed in the male housing 42, and the guiding portions 18 are formed on the female housing 12. For this reason, the tabs 45 of the male terminals 41 are appropriately guided in the guiding portions 18, and the state where the female terminals 11 and the male terminals 41 are electrically connected is reliably realized.

In particular, in the configuration of the first embodiment, with respect to the width direction, the gap (W2) in the width direction that may be formed between an outer surface of the base-end side of the protrusion 28 and an inner surface of the escape portion 82 is larger than the gap (W1) in the width direction that may be formed between an outer surface on the distal end side of the protrusion 28 and an inner surface of the recess 63 (W1<W2). For this reason, interference of the protrusion 28 with the inner surfaces of the escape portion 82 can be avoided, and the state where the distal end side of the protrusion 28 is positioned in the recess 63 in the width direction can be more appropriately realized. Also, in the first embodiment, the female housing 12, the male housing 42, and the moving plate 44 are longer in the width direction than in the height direction. The protrusion 28 is formed in the center region in the width direction of one long side portion 22 of the female housing 12, the escape portion 82 is formed in the center region in the width direction of one long side portion 75 of the peripheral wall portion 73, and the recess 63 is formed in the center region in the width direction of one long side portion 53 of the hood portion 56 of the male housing 42. That is, since the fitting part of the recess 63 and the protrusion 28 is formed in the center region in the width direction of the long side portions 22 and 53 of the female housing 12 and the hood portion 56, displacement in the width direction of the female housing 12 and hood portion 56 can be effectively prevented with a simple structure.

Also, the male connector 40 has the lever 43 rotatably supported with respect to the male housing 42, and the lever 43 includes the pair of cam grooves 68. The male housing 42 has the pair of pin escape portions 62 in the center region in the height direction of the short side portions 54. The peripheral wall portion 73 has the pair of male cam pins 77 respectively disposed inside the cam grooves 68 via the pin escape portions 62, in the center region in the height direction of the short side portions 76. The female housing 12 includes the pair of female cam pins 26 that are to be combined with the male cam pins 77 in the center region in the height direction of the short side portions 23.

In other words, in the first embodiment, the female cam pins 26, the pin escape portions 62, and the male cam pins 77 are located in the center region in the height direction of the short side portions 23, 54, and 76, and the recess 63, the escape portion 82, and the protrusion 28 are disposed in the center region in the width direction of the long side portions 53, 75, and 22. For this reason, it is possible to reduce structural constraints between the structures of the female cam pins 26, the pin escape portions 62, and the male cam pins 77 and the structures of the recess 63, the escape portion 82, and the protrusion 28.

Further, the female housing 12 has the female housing body 14 holding the female terminals 11, and the female holder 15 surrounding the female housing body 14. The male housing 42 includes the male housing body 46 holding the male terminals 41, and the male holder 47 surrounding the male housing body 46. The protrusion 28 is formed on the female holder 15, and the recess 63 is formed in the male holder 47. In the above configuration, by the distal end side of the protrusion 28 being fitted into the recess 63 in the positioned state, the fitting state of the connector can be realized, and the connection state of the female terminals 11 and the male terminals 41 can be realized. It is not necessary to form the recess 63 or the protrusion 28 in the female housing body 14 and the male housing body 46.

### Other Embodiments of the Present Disclosure

Note that the first embodiment disclosed herein is to be considered as illustrative and non-limiting in all aspects.

In the first embodiment, the recess is formed in the hood portion, and the protrusion is formed in the female housing. Alternatively, in another embodiment, it is also possible that the protrusion is formed in the hood portion and the recess is formed in the female housing.

In the first embodiment, the recess is formed in the male holder, and the protrusion is formed in the female holder. Alternatively, in another embodiment, it is also possible that the recess is formed in the male housing body or the female housing body, and the protrusion is formed in the female housing body or the male housing body.

In the first embodiment, the female housing is formed by the female housing body and the female holder, and the male housing is formed by the male housing body and the male holder. Alternatively, in another embodiment, it is also possible that the female housing is formed by the female housing body and the female holder formed integrally in one piece, and the male housing is formed by the male housing body and the male holder formed integrally in one piece.

In the first embodiment, the female housing body is formed by the plurality of female sub housings, and the male housing body is formed by the plurality of male sub housings. Alternatively, in another embodiment, it is also possible that the female housing body is formed in one piece on the whole, and the male housing body is formed in one piece on the whole.

In the first embodiment, the male connector has a lever, and the moving plate moves inside the hood portion by rotation of the lever. Alternatively, in another embodiment, it is also possible that the male connector has no lever, and the moving plate moves inside the hood portion by being pressed by the female housing, for example.

In the first embodiment, the recess is shaped as a bottomed recess that is open at the inner surface of the long side portion of the hood portion and closed at the outer surface of the long side portion of the hood portion. Alternatively, in another embodiment, it is also possible that the recess is shaped as a bottomless recess that passes through the corresponding wall of the female housing or the hood portion in the thickness direction.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a female connector and a male connector that are fittable to each other,
wherein the female connector includes a female terminal and a female housing configured to house the female terminal,
the male connector includes a male terminal, a male housing configured to house the male terminal, and a moving plate movable in a fitting direction with respect to the male housing,
the male terminal includes a tab,
the male housing includes a hood portion from which the tab protrudes,
the moving plate includes a peripheral wall portion disposed along an inner surface of the hood portion, a plate body configured to position the tab inside the hood portion, and an escape portion extending through the peripheral wall portion in a thickness direction,
the female housing is disposed inside the peripheral wall portion,
either one of the female housing and the hood portion has a protrusion, and another one of the female housing and the hood portion has a recess, and
in a fitting state of the female connector and the male connector, a base end side of the protrusion is disposed inside the escape portion, and a distal end side of the protrusion is fitted and positioned in the recess.

2. The connector according to claim 1,
wherein, with respect to a width direction orthogonal to a height direction that is a direction in which the protrusion protrudes and the recess is recessed, a gap in the width direction that is possibly formed between an outer surface on the base end side of the protrusion and an inner surface of the escape portion is set larger than a gap in the width direction that is possibly formed between an inner surface on the distal end side of the protrusion and an inner surface of the recess.

3. The connector according to claim 1,
wherein, with respect to a width direction orthogonal to a height direction that is a direction in which the protrusion protrudes and the recess is recessed, the female housing, the male housing, and the moving plate are longer in the width direction than in the height direction,
the protrusion is formed in a center region in the width direction of a long side portion of the one of the female housing and the hood portion,
the escape portion is formed in a center region in the width direction of a long side portion of the peripheral wall portion, and
the recess is formed in a center region in the width direction of a long side portion of the other one of the female housing and the hood portion.

4. The connector according to claim 3,
wherein the male connector includes a lever supported rotatable with respect to the male housing,
the lever includes a cam groove,
the male housing includes a pin escape portion in a center region in the height direction of a short side portion,
the peripheral wall portion includes a male cam pin configured to be disposed inside the cam groove via the pin escape portion, in a center region in the height direction of a short side portion, and
the female housing includes a female cam pin configured to be combined with the male cam pin, in a center region in the height direction of a short side portion.

5. The connector according to claim 1,
wherein the female housing includes a female housing body configured to hold the female terminal, and a female holder surrounding the female housing body,
the male housing includes a male housing body configured to hold the male terminal, and a male holder surrounding the male housing body, and
the protrusion is formed on the one of the female holder and the male holder, and the recess is formed in the other one of the female holder and the male holder.
